(19) United States
(12) Patent Application Publication
(10) Pub. No.: US 2021/0293080 A1
(43) Pub. Date: Sep. 23, 2021

(54) Frame Forming Structure for Use with Frame and Sash of Aluminium-Wood Combined Door/Window

(71) Applicant: ZHEJIANG ROOMEYE ENERGY-SAVING TECHNOLOGY CO., LTD, Huzhou City, Zhejiang (CN)

(72) Inventors: Chengming DONG, Huzhou City, Zhejiang (CN); Haihua XU, Huzhou City, Zhejiang (CN); Chengjie HE, Huzhou City, Zhejiang (CN)

(21) Appl. No.: 16/474,559

(22) PCT Filed: Mar. 30, 2018
(86) PCT No.: PCT/CN2018/081242

§ 371 Date: Jun. 28, 2019

(30) Foreign Application Priority Data
Mar. 30, 2017 (CN) 201710201278.9

(51) Int. Cl. E06B 3/984; E06B 3/988

(52) U.S. Cl. CPC E06B 3/9845; E06B 3/9646; E06B 3/9885

(57) ABSTRACT

Provided is a frame forming structure for use with a frame and a sash of an aluminium-wood combined door/window. The door/window may include at least a door/window frame or a door/window sash frame. The door/window frame or the door/window sash frame is formed by two connecting adjacent profile frame strips by means of an angle forming device and a round tenon rod on adjacent connecting end surfaces. Symmetric U-shaped notches for positioning the angle forming device and symmetric round tenon rod holes are processed on the connecting end surfaces of the two adjacent profile frame strips. A round tenon rod is used for positioning and inserted into the symmetric round tenon rod holes. A assembly-type the angle forming device is fixed the two adjacent profile frame strips. The disclosure has characteristics of increasing connecting strength of an angle portion and sealing performance after angle formation, improving convenience of frame formation.

### TECHNICAL FIELD

The disclosure relates to a frame forming structure of an aluminium-wood combined wood frame sash, and belongs to the field of building door/window technologies.

### BACKGROUND

A frame forming way of a sash of a traditional aluminium-wood combined door/window is characterized in that an angle forming process of a round tenon rod and a dovetail tenon is taken when a formed angle of 45° is applied to an angle portion. A dovetail tenon groove is milled on wood, a plastic dovetail tenon is hammered and positioned with the round tenon rod, and an surface is gelatinized. However, an overall strength after angle formation is unsatisfactory because the dovetail tenon is prepared from nylon and due to its own structure, and as time goes on, part of connecting places may be trapped in untight sealing and other phenomena and accordingly trapped in water seepage, mildewing and other phenomena.

### TECHNICAL PROBLEMS

In order to overcome disadvantages of the related technology, the disclosure provides a frame forming structure of an aluminium-wood combined wood frame sash, and the frame forming structure may increase connecting strength of an angle portion and sealing performance after angle formation while improving convenience of frame formation and increasing manufacturing efficiency.

### TECHNICAL SOLUTIONS

An objective of the disclosure is completed by the following technical solutions of some embodiments: a frame forming structure for use with a frame and a sash of an aluminium-wood combined door/window is characterized in that the door/window includes at least a door/window frame or a door/window sash frame. The door/window frame or the door/window sash frame is formed by two connecting adjacent profile frame strips by means of an angle forming device and a round tenon rod on adjacent connecting end surfaces, The connecting end surfaces of two adjacent profile frame strips are processed to have a section at an angle of 0-60° with respect to an end plane of a normal profile frame strip respectively, and are interconnected to form a perpendicular frame edge, Symmetric U-shaped notches for positioning the angle forming device and symmetric round tenon rod holes are processed on the connecting end surfaces of the two adjacent profile frame strips, respectively. A round tenon rod, which is used for positioning, is inserted into the symmetric round tenon rod holes. When the two adjacent profile frame strips are mutually spliced, a space which accommodates assembly-type the angle forming device is formed at a splicing location. The Assembly-type the angle forming device is formed by combining two halves of the angle forming device, and each half of the two halves of the angle forming device is corresponding fixed in each of the U-shaped notches of positioning adjacent profile frame strips with a bolt. The two halves of the angle forming device are mechanically tightened by means of a bevel gear pair mechanism which is meshed through pairing, to tightly fix and connect the two adjacent profile frame strips.

In an exemplary embodiment, the angle forming device is formed by combining the two halves of the angle forming device, a positioning pin, a cover plate, a bevel gear pair of the angle forming device. The two halves of the angle forming device is a fixing substrate having two fixing holes and a gear hole, A side of one half of the angle forming device is provided with one gear hole and a cover plate connecting with the one half of the angle forming device as well. The positioning pin is a hollow cylindrical fastener, and both ends of the positioning pin are connected into the fixing holes which are arranged on opposite end surfaces of the two halves of the angle forming device, The bevel gear pair of the angle forming device is formed by meshing a bevel gear and a perpendicular bevel gear, the bevel gear is positioned between two positioning pins and has a screw, the perpendicular bevel gear is perpendicularly arranged in the gear hole and has a rotating head.

In an exemplary embodiment, a layer of single-component glue is processed in the U-shaped notches of two adjacent profile frame strips, respectively. A bottom of each of the U-shaped notches is provided with two pre-drilling holes, and the two halves of the angle forming device are fixed in the U-shaped notches when nailed through the two pre-drilling holes with the bolt, respectively. The connecting end surfaces of the two adjacent profile frame strips are processed into a section at an angle of 45° respectively, and each of the U-shaped notches is positioned on a middle end surface of the section at an angle of 45°.

### BENEFICIAL EFFECTS

The disclosure positions with a round tenon rod and a positioning pin of an angle forming device and tightens with a bevel gear, thereby effectively ensuring connecting strength of an angle portion and sealing performance after angle formation and guaranteeing flatness. Furthermore, the disclosure has characteristics of increasing the connecting strength of the angle portion and the sealing performance after the angle formation, increasing convenience of frame formation, improving manufacturing efficiency, and the like.

### BRIEF DESCRIPTION OF THE DRAWINGS

FIG. 1 is a schematic diagram of an inner structure of an embodiment of the disclosure.

FIG. 2 is a structure diagram of an embodiment of the disclosure upon completion of installation.

FIG. 3 is a structure diagram of an angle forming device of an embodiment of the disclosure.

### DETAILED DESCRIPTION OF THE PREFERRED EMBODIMENT

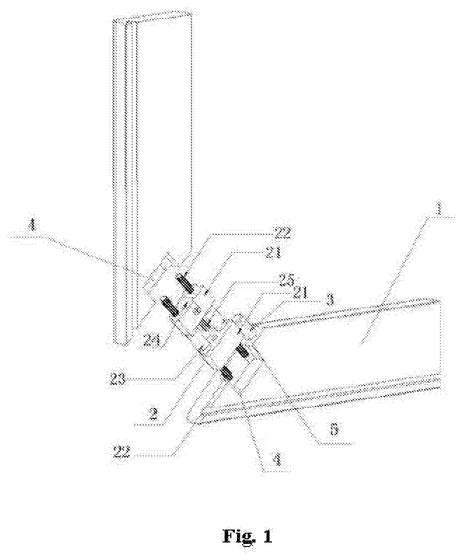

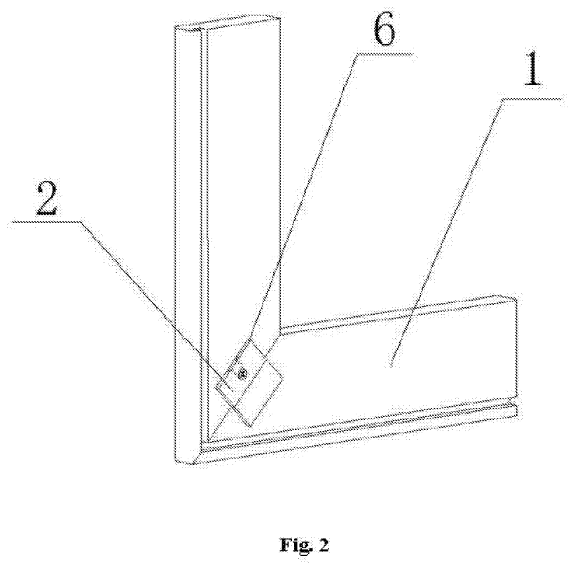

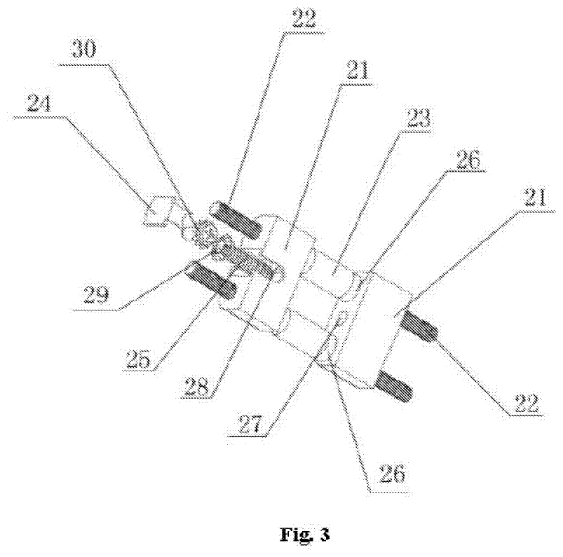

The disclosure will be introduced in detail below in combination with the drawings: as shown in FIG. 1 to FIG. 3, a frame forming structure for use with a frame and a sash of an aluminium-wood combined door/window provided by the disclosure is characterized in that the door/window includes at least a door/window frame or a door/window sash frame. The door/window frame or the door/window sash frame is formed by two connecting adjacent profile frame strips 1 by means of an angle forming device 2 and a round tenon rod 3 on adjacent connecting end surfaces. The connecting end surfaces of two adjacent profile frame strips 1 are processed to have a section at an angle of 0-60° with respect to an end, plane of a normal profile frame strip respectively, and are interconnected to form a perpendicular frame edge. Symmetric U-shaped notches 4 for positioning the angle forming device and symmetric round tenon rod holes 5 are processed on the connecting end surfaces of the two adjacent profile frame strips 1, respectively. A round tenon rod 6, which is used fore positioning, is inserted into the symmetric round tenon rod holes 5. When the two adjacent profile frame strips 1 are mutually spliced, a space 7 which accommodates assembly-type the angle forming device 2 is formed at a splicing location. The assembly-type the angle forming device 2 is formed by combining two halves of the angle forming device 21 and each half of which is corresponding fixed in each of the U-shaped notches 4 of positioning adjacent profile frame strips with a bolt 22. The two halves of the angle forming device 21 are mechanically tightened by means of a bevel gear pair mechanism which is meshed through pairing, to tightly fix and connect two adjacent profile frame strips 1,

As shown in figures, the angle forming, device 2 is formed by combining the two halves of the angle forming device 21, a positioning pin 23, a cover plate 24 and the bevel gear pair mechanism 25 of the angle forming device. The two halves of the angle forming device 21 are a fixing substrate having two fixing holes 26 and a gear hole 27. Herein, a side of one half of the angle forming device 21 is provided with a gear hole channel 28 and a cover plate 24 connecting with the one half of the angle forming device as well. The positioning pin 29 is a hollow cylindrical fastener, and both ends of the positioning pin 29 are connected into the fixing holes 26 which are arranged on opposite end surfaces of the two halves of the angle forming device 21, respectively. The bevel gear pair mechanism 25 of the angle forming device is formed by meshing a bevel gear 30 and a perpendicular bevel gear 31, the bevel gear is positioned between two positioning pins 29 and has a screw, and the perpendicular bevel gear 31 is perpendicularly arranged in the gear hole channel 28 and has a rotating head.

A layer of single-component glue is processed in the U-shaped notches 4 of two adjacent profile frame strips 1 of the disclosure, respectively. A bottom of each of the U-shaped notches 4 is provided with two pre-drilling holes, and the two halves of the angle forming device 21 are fixed in the U-shaped notches 4 when nailed through the two pre-drilling holes with the bolt 22, respectively. The connecting end surfaces of the two adjacent profile frame strips 1 are optimally processed into a section at an angle of 45° respectively, and each of the U-shaped notches 4 is positioned on a middle end surface of the section at an angle of 45°.

### DETAILED DESCRIPTION OF THE EMBODIMENTS

The disclosure will be introduced in detail below in combination with the drawings: as shown in FIG. 1 to FIG. 3, a frame forming structure for use with a frame and a sash of an aluminium-wood combined door/window provided by the disclosure is characterized in that the door/window includes at least a door/window frame or a door/window sash frame. The door/window frame or the door/window sash frame is formed by two connecting adjacent profile frame strips 1 by means of an angle forming device 2 and a round tenon rod 3 on adjacent connecting end surfaces. The connecting end surfaces of two adjacent profile frame strips 1 are processed to have a section at an angle of 0-60° with respect to an end plane of a normal profile frame strip respectively, and are interconnected to form a perpendicular frame edge. Symmetric U-shaped notches 4 for positioning the angle forming device and symmetric round tenon rod holes 5 are processed on the connecting end surfaces of the two adjacent profile frame strips 1, respectively. A round tenon rod 6, which is used for positioning, is inserted into the symmetric round tenon rod holes 5. When the two adjacent, profile frame strips 1 are mutually spliced, a space 7 which accommodates assembly-type the angle forming device 2 is formed at a splicing location. The assembly-type the angle forming device 2 is formed by combining two halves of the angle forming device 21 and each half of which is corresponding fixed in each of the U-shaped notches 4 of positioning adjacent profile frame strips with a bolt 22. The two halves of the angle forming device 21 are mechanically tightened by means of a bevel gear pair mechanism which is meshed through pairing, to tightly fix and connect two adjacent profile frame strips 1.

As shown in figures, the angle forming device 2 is formed by combining the two halves of the angle forming device 21, a positioning pin 23, a cover plate 24 and the bevel gear pair mechanism 25 of the angle forming device. The two halves of the angle forming device 21 are a fixing substrate having two fixing holes 26 and a gear hole 27. Herein, a side of one half of the angle forming device 21 is provided with a gear hole channel 28 and a cover plate 24 connecting with the one half of the angle forming device as well. The positioning pin 29 is a hollow cylindrical fastener, and both ends of the positioning pin 29 are connected into the fixing holes 26 which are arranged on opposite end surfaces of the two halves of the angle forming device 21, respectively. The bevel gear pair mechanism 25 of the angle forming device is formed by meshing a bevel gear 30 and a perpendicular bevel gear 31, the bevel gear is positioned between two positioning pins 29 and has a screw, and the perpendicular bevel gear 31 is perpendicularly arranged in the gear hole channel 28 and has a rotating head.

A layer of single-component glue is processed in the U-shaped notches 4 of two adjacent profile frame strips 1 of the disclosure, respectively. A bottom of each of the U-shaped notches 4 is provided with two pre-drilling holes, and the two halves of the angle forming device 21 are fixed in the U-shaped notches 4 when nailed through the two pre-drilling holes with the bolt 22, respectively. The connecting end surfaces of the two adjacent profile frame strips 1 are optimally processed into a section at an angle of 45° respectively, and each of the U-shaped notches 4 is positioned on a middle end surface of the section at an angle of 45°.

The disclosure positions with the round tenon rod and the positioning pin of the angle forming device and tightens with the bevel gear, thereby effectively ensuring connecting strength of an angle portion and sealing performance after angle formation and guaranteeing flatness. Furthermore, the disclosure has characteristics of increasing the connecting strength of the angle portion and the sealing performance after the angle formation, increasing convenience of frame formation, improving manufacturing efficiency, and the like.

### INDUSTRIAL APPLICABILITY

The disclosure positions with a round tenon rod and a positioning pin of an angle forming device and tightens with a bevel gear, thereby effectively ensuring connecting strength of an angle portion and sealing performance after angle formation and guaranteeing flatness. Furthermore, the disclosure has characteristics of increasing the connecting strength of the angle portion and the sealing performance after the angle formation, increasing convenience of frame formation, improving manufacturing efficiency, and the like.

What is claimed is:

1. A frame forming structure for use with a frame and a sash of an aluminium-wood combined door/window, comprising at least a door/window frame or a door/window sash frame, wherein the door/window frame or the door/window sash frame is formed by two connecting adjacent profile frame strips by means of an angle forming device and a round tenon rod on adjacent connecting end surfaces of the connecting adjacent profile frame strips; the connecting end surfaces of two adjacent profile frame strips are processed to have a section at an angle of 0-60° with respect to an end plane of a normal profile frame strip respectively, and are interconnected to form a perpendicular frame edge; symmetric U-shaped notches for positioning the angle forming device and symmetric round tenon rod holes are processed on the connecting end surfaces of the two adjacent profile frame strips, respectively; a round tenon rod, which is used for positioning, is inserted into the symmetric round tenon rod holes; when the two adjacent profile frame strips are mutually spliced, a space which accommodates assembly-type the angle forming device is formed at a splicing location; the assembly-type the angle forming device is formed by combining two halves of the angle forming device, and each half of the two halves of the angle forming device is corresponding fixed in each of the U-shaped notches of positioning adjacent profile frame strips with a bolt; and the two halves of the angle forming device are mechanically tightened by means of a bevel gear, pair mechanism which is meshed through pairing, to tightly fix and connect the two adjacent profile frame strips.

2. The frame forming structure for use with a frame and a sash of an aluminium-wood combined door/window as claimed in claim 1, wherein the angle forming device is formed by combining the two halves of the angle forming device, a positioning pin, a cover plate and a level gear pair mechanism of the angle forming device; the two halves of the angle forming device is a fixing substrate having two fixing holes and a gear hole, wherein a side of one half of the angle forming device is provided with one gear hole and a cover plate connecting with the one half of the angle forming device as well; the positioning pin is a hollow cylindrical fastener, and both ends of the positioning pin are connected into the fixing holes which are arranged on opposite end surfaces of the two halves of the angle forming device, respectively; the bevel gear pair mechanism of the angle forming device is formed by meshing a bevel gear and a perpendicular bevel gear, the bevel gear is positioned between two positioning pins and has a screw, the perpendicular bevel gear is perpendicularly arranged in the gear hole and has a rotating head.

3. The frame forming structure for use with a frame and a sash of an aluminium-wood combined door/window as claimed in claim 1, wherein a layer of single-component glue is processed in the U-shaped notches of the two adjacent profile frame strips, respectively; a bottom of each of the U-shaped notches is provided with two pre-drilling holes, and the two halves of the angle forming device are fixed in the U-shaped notches when nailed through the two pre-drilling holes with the bolt, respectively; the connecting end surfaces of the two adjacent profile frame strips are processed into a section at an angle of 45° respectively, and each of the U-shaped notches is positioned on a middle end surface of the section at an angle of 45°.

4. The frame forming structure for use with a frame and a sash of an aluminium-wood combined door/window as claimed in claim 2, wherein a layer of single-component glue is processed in the U-shaped notches of the two adjacent profile frame strips, respectively; a bottom of each of the U-shaped notches is provided with two pre-drilling holes, and the two halves of the angle forming device are fixed in the U-shaped notches when nailed through the two pre-drilling holes with the bolt, respectively; the connecting end surfaces of the two adjacent profile frame strips are processed into a section at an angle of 45° respectively, and each of the U-shaped notches is positioned on a middle end surface of the section at an angle of 45°.
